(19) United States
(12) Patent Application Publication
(10) Pub. No.: US 2009/0319505 A1
(43) Pub. Date: Dec. 24, 2009

(54) TECHNIQUES FOR EXTRACTING AUTHORSHIP DATES OF DOCUMENTS

(75) Inventors: Hang Li, Beijing (CN); Yunhua Hu, Beijing (CN); Guangping Gao, Beijing (CN); Yauhen Shnitko, Redmond, WA (US); Dmitriy Meyerzon, Bellevue, WA (US); David Mowatt, Seattle, WA (US)

Correspondence Address: MICROSOFT CORPORATION, ONE MICROSOFT WAY, REDMOND, WA, 98052, US

(73) Assignee: Microsoft Corporation, Redmond, WA (US)

(21) Appl. No.: 12/141,935

(22) Filed: Jun. 19, 2008

(51) Int. Cl. G06F 7/06; G06F 17/30

(52) U.S. Cl. 707/5; 707/3; 707/E17.014

(57) ABSTRACT

Various technologies and techniques are disclosed for calculating authorship dates for a document. A portion of a document to select to look for possible authorship dates is determined. The possible authorship dates are extracted from the portion of the document. A revised authorship date of the document is generated using a neural network. The revised authorship date is returned to an application or process that requested the date.

### BACKGROUND

Metadata about a particular document, such as the author, title, and date can be useful for several reasons. For example, search engines and document management systems can use metadata to allow the user to see when a document was authored, to contribute to relevance ranking, or to limit the search results to only data having certain metadata, such as a date falling into a specified time range.

Unfortunately, the accuracy of the date metadata that gets automatically set on documents tends to be very low. The date metadata that users typically want is the time at which the author finished writing the document, yet the date associated with documents does not reflect this. There are several reasons for the low accuracy on date metadata. One reason for such low accuracy is that when documents are uploaded or copied to collaboration websites, the date metadata gets changed from the last modification date to the upload date, which is rarely a significant or helpful date. Another common reason is that when other document metadata is changed (e.g. publication status), the last modified date can get changed even though no text in the document changed, and thus the data metadata does not reflect reality.

### SUMMARY

Various technologies and techniques are disclosed for calculating authorship dates for a document. A portion of a document to select to look for possible authorship dates is determined. The possible authorship dates are extracted from the portion of the document. A revised authorship date of the document is generated using a neural network.

In one implementation, a method for calculating a revised authorship date for a document is described. Some possible authorship dates are extracted from a document. Features are extracted for each possible authorship date. Some weights are assigned to the features. An overall probability score is calculated for the features. When the overall probability score is above a pre-determined threshold, the possible authorship date is added to a list of possible authorship dates for the document. The retrieving, extracting, giving, calculating, and adding steps are repeated for a plurality of possible authorship dates. The revised authorship date is chosen from the list of possible authorship dates.

In another implementation, techniques for calculating an authorship date for a document when requested by a requesting application are described. A request is received from a requesting application for an authorship date for a document. The authorship date is calculated for the document using a neural network. The authorship date is sent back to the requesting application. One non-limiting example of a requesting application is a program that is displaying the document. Another non-limiting example of a requesting application includes a search engine. Yet another non-limiting example of a requesting application includes a content management application.

This Summary was provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

### BRIEF DESCRIPTION OF THE DRAWINGS

FIG. 1 is a diagrammatic view of a date extraction system of one implementation.

FIG. 2 is a process flow diagram for one implementation illustrating the stages involved in calculating a revised authorship date upon request from a requesting application.

FIG. 3 is a process flow diagram for one implementation illustrating the high level stages involved in generating a revised authorship date for one or more documents.

FIG. 4 is a process flow diagram for one implementation illustrating the stages involved in generating a revised authorship date for one or more documents.

FIG. 5 is a process flow diagram for one implementation illustrating the stages involved in determining which dates to include as possible authorship dates of a document.

FIG. 6 is a diagrammatic view for one implementation illustrating a single layer neural network to generate the revised authorship date for a document.

FIGS. 7a-7b contains a diagrammatic view of exemplary features of one implementation that can be used to help determine whether a date should be included as a possible authorship date of a document.

FIG. 8 is a diagrammatic view of a computer system of one implementation.

### DETAILED DESCRIPTION

The technologies and techniques herein may be described in the general context as an application that programmatically calculates an authorship date of a document, but the technologies and techniques also serve other purposes in addition to these. In one implementation, one or more of the techniques described herein can be implemented as features within any type of program or service that is responsible for calculating or requesting the authorship dates of documents.

In one implementation, techniques are described for calculating an authorship date of a given document programmatically, such as using a neural network like a single layer neural network (also called a perceptron model). A “single layer neural network” has a single layer of output nodes where the inputs are directly fed to the outputs through a series of weights. In this way, a single layer neural network is a simple kind of feed-forward network. In other words, the sum of the products of the weights and the inputs is calculated in each node, and if the value is above some threshold (typically 0), then the neuron fires and takes the activated value (typically 1); otherwise the neuron takes the deactivated value (typically −1).

With respect to calculating an authorship date of a document, various features (the input criteria) can be evaluated using the neural network to determine how likely it is that each date being considered is the authorship date of the document. The resulting probability score generated for each possible date that is produced by the neural network can be used to choose the authorship date. In one implementation, the neural network is utilized by a date extraction system to determine an authorship date of a document upon request. A date extraction system utilizing a neural network is described in further detail herein.

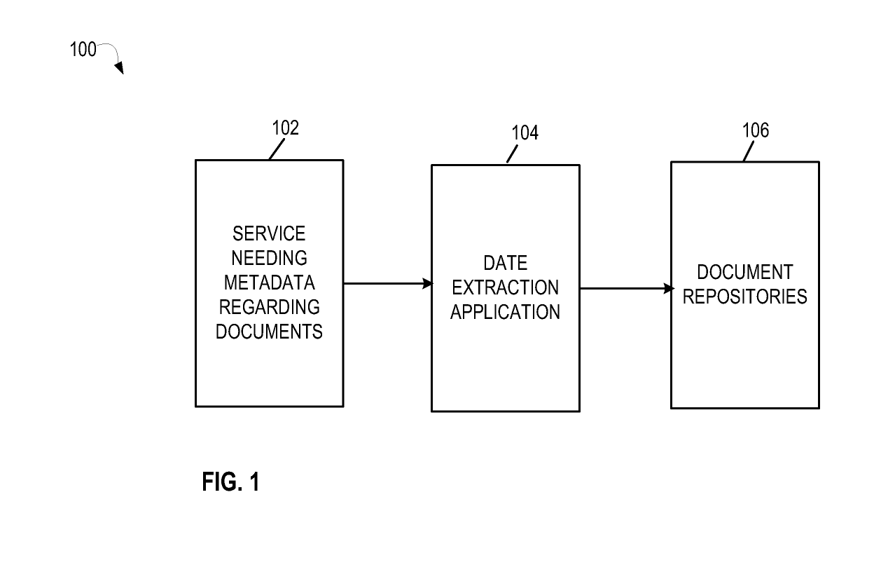

FIG. 1 is a diagrammatic view of a date extraction system 100 of one implementation. A service needing metadata 102 regarding a given document sends a request to a date extraction application 104 to analyze the document to see if a revised authorship date is available. Data extraction application 104 accesses the document in one or more document repositories 106. Date extraction application 104 then attempts to calculate the revised date and if a revised date is found, the revised date is returned to the service needing metadata 102.

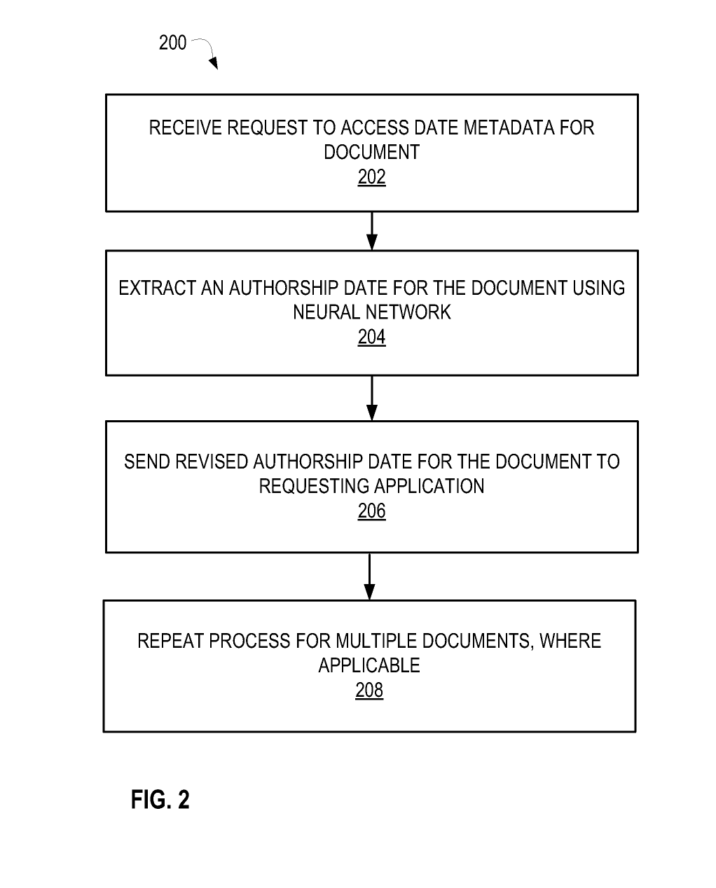

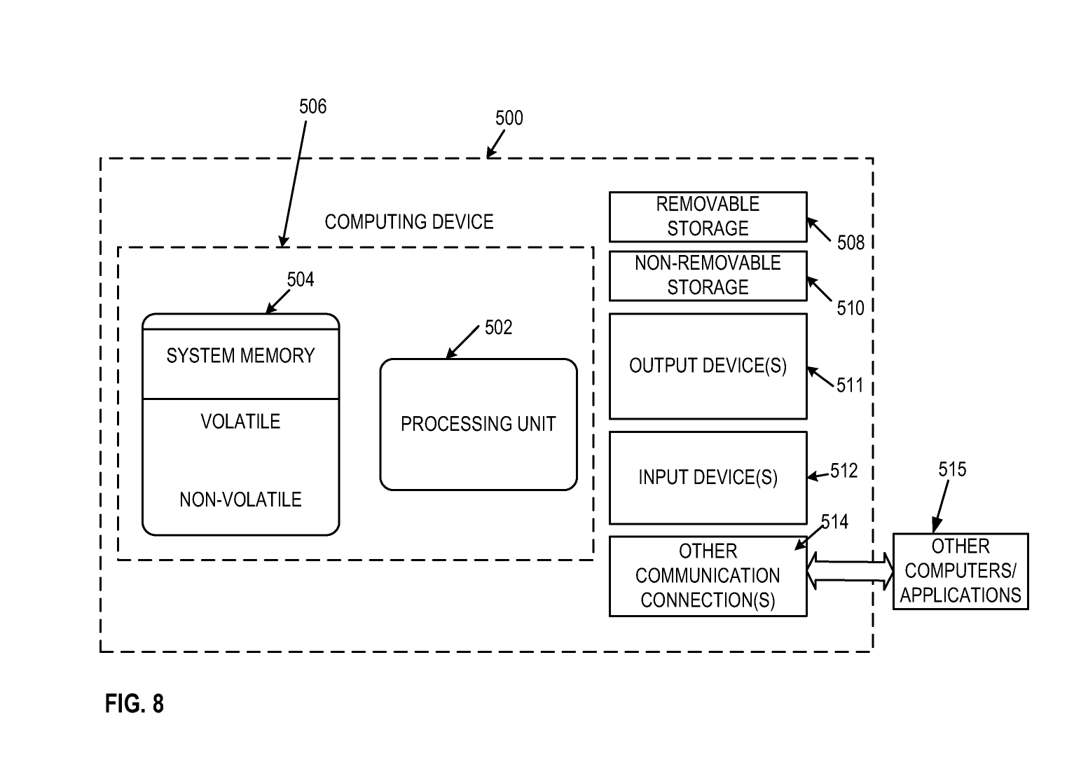

Turning now to FIGS. 2-7, the stages for implementing one or more implementations of date extraction system 100 are described in further detail. In some implementations, the processes of FIG. 2-7 are at least partially implemented in the operating logic of computing device 500 (of FIG. 8).

FIG. 2 is a process flow diagram 200 for one implementation illustrating the stages involved in calculating a revised authorship date upon request from a requesting application. A request is received to access date metadata for a document (stage 202) from a requesting application or process. A few non-limiting examples of requesting applications include a program that is displaying a document (such as a word processor), a search engine (such as MICROSOFT® LiveSearch) or a content management application (such as MICROSOFT® SharePoint). This revised date metadata may be shown in the search results so that the user can better pick the document they are looking for. In another implementation, the revised date metadata can be used to search for documents that meet a certain criteria. An authorship date is calculated for the document using a neural network (stage 204). The revised authorship date for the document is sent to the requesting application (stage 206). The process is repeated for multiple documents, where applicable (stage 208).

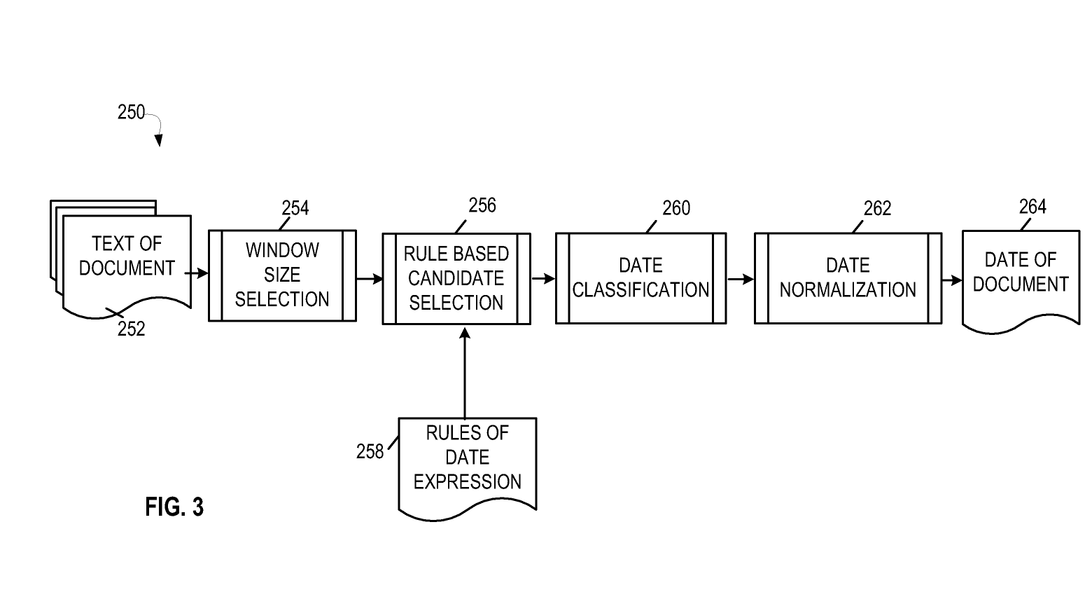

In one implementation, some or all of these techniques can be used when a search engine or content management application has requested authorship date information for one or more documents. In another implementation, some or all of these techniques can be used when one or more files are being copied over a network using a file copy process to update the date metadata associated with the document so that it is more accurate. Some techniques for determining an authorship date of a document will now be described in further detail in FIGS. 3-7.

FIG. 3 is a process flow diagram 250 for one implementation illustrating the high level stages involved in generating a revised authorship date for one or more documents. The process begins at some point when a requesting application has asked for a revised authorship date of one or more documents 252. During a window size selection process 254, a determination is made as to what portion of the document to analyze for date candidates. In other words, a determination is made as to which sections of the document to scan for possible dates that should be considered as a possible authorship date. In one implementation, during window size selection, a certain number of characters (such as 1,600 characters) are retrieved from the beginning section and the ending section of the document, respectively. In other implementations, a different number of characters and/or different portions of the document can be retrieved.

Once the window size selection process 254 has been performed, a rule-based candidate selection process 256 is then performed. In one implementation, candidate selection is conducted by using some rules of date expressions 258. In other words, these rules can specify the types of formats that will be searched for and considered as dates. Examples of formats within the document that may be considered as dates can include MM-DD-YYYY, MM-DD-YY, DD/MM/YYYY, DD/MM/YY, etc.

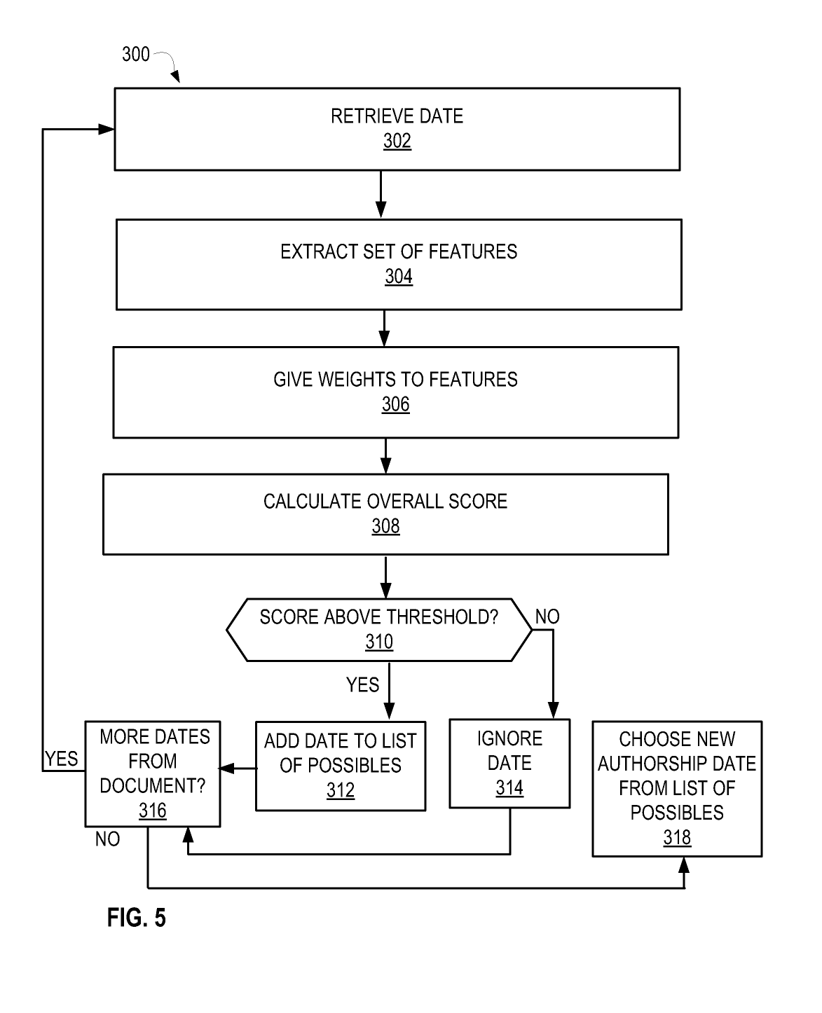

After the rule-based candidate selection process 256 has been performed, a date classification process 260 is then performed. During the date classification process 260, a probability score is calculated for each extracted date by comparing the extracted date to various features within a neural network. The term “feature” as used herein is meant to include criteria that is considered by the neural network for which a result is assigned based upon an evaluation of the criteria. The use of features and a neural network to perform date classification is described in further detail in FIGS. 5-7.

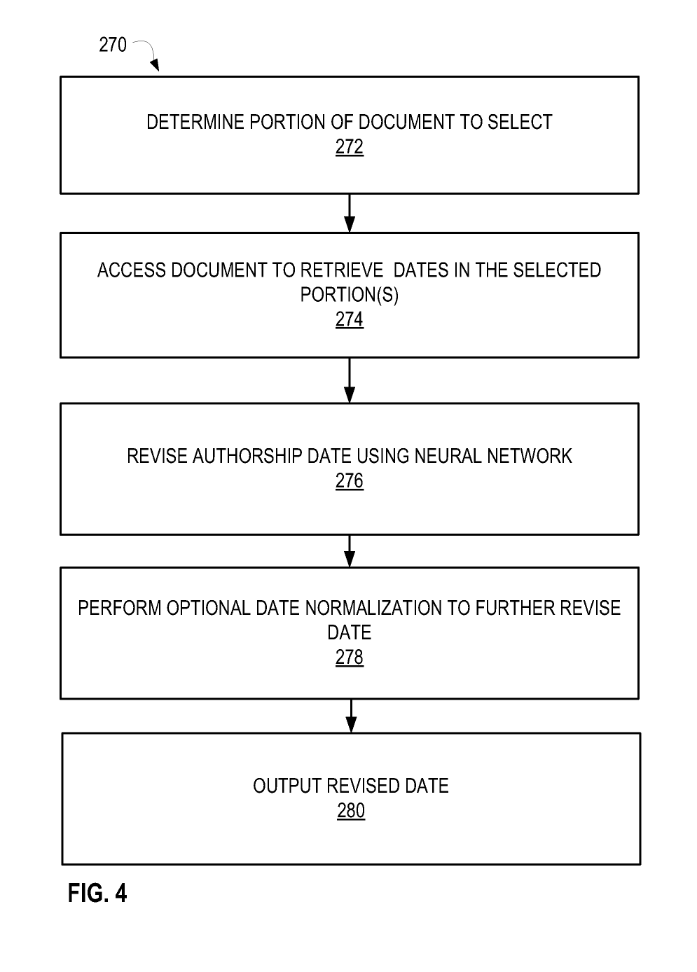

Once all of the possible authorship dates are identified, some date normalization work can be performed to convert all date expressions into a uniform format. For example, “Nov. 30, 2007” could be converted into “Nov. 30, 2007” and “Nov. 30, 2007” could be converted into “Nov. 30, 2007”. The revised authorship date of the document 264 can then be selected from the complete list of possible authorship dates, such as the one having the highest probability score from the neural network analysis. The process can be repeated for multiple documents when applicable, such as when a requesting application is asking for revised authorship dates for multiple documents. Each of these steps will now be described in further detail in FIGS. 4-7.

FIG. 4 is a process flow diagram 270 for one implementation illustrating the stages involved in generating a revised authorship date for one or more documents. A determination is made for the portion of the document to select (stage 272). The document is accessed to retrieve the dates in the selected portion(s) of the document (stage 274). A revised authorship date is determined using a neural network, such as a single layer neural network (stage 276). In one implementation, a neural network can be selected based upon some criteria, such as the language being used in the document being evaluated, the file type of the document, the type of domain or document template to which the document applies, and so on. Date normalization is performed to further revise the dates to a uniform format (stage 278). A revised authorship date is selected from the list of possible dates that were identified, and the revised date is output to the requesting application or process (stage 280).

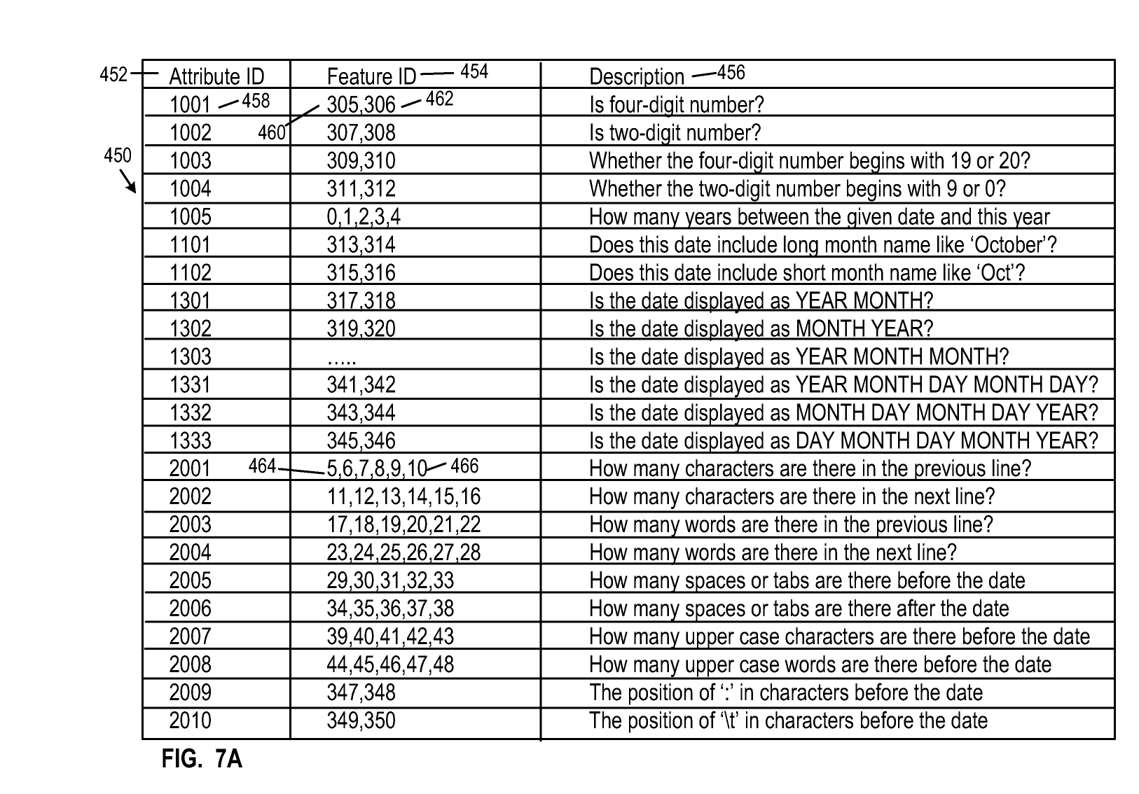

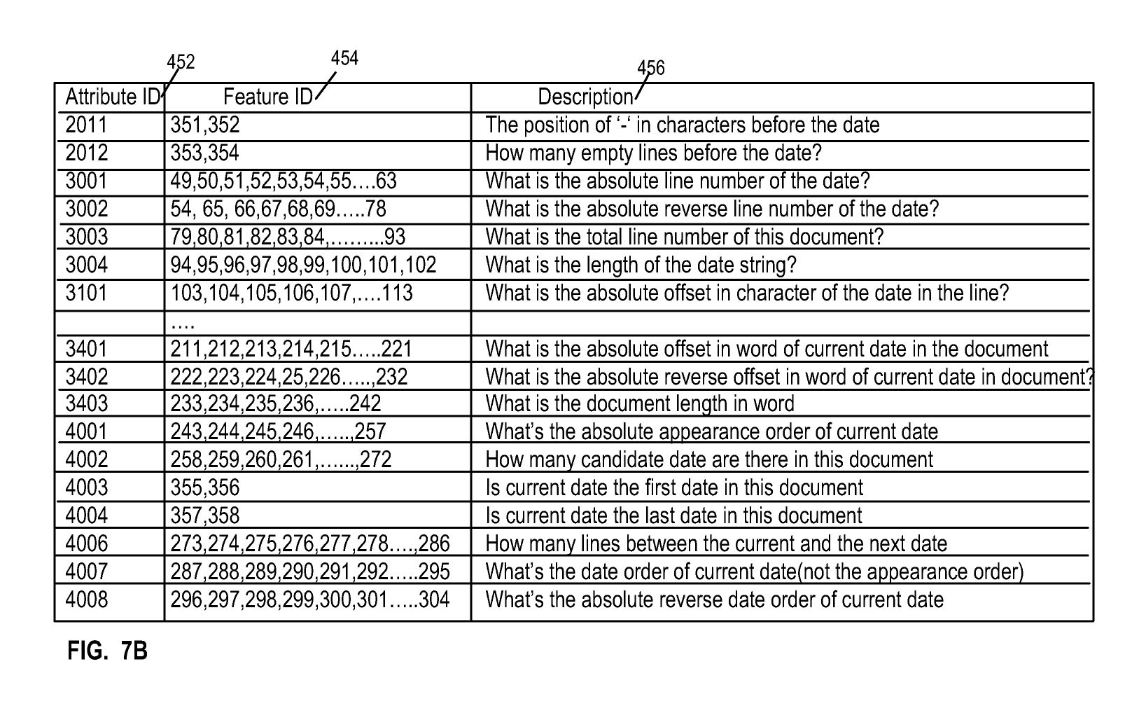

FIG. 5 is a process flow diagram 300 for one implementation illustrating the stages involved in determining which dates to include as possible authorship dates of a document. A date is retrieved (stage 302), and a set of features is extracted for the date (stage 304). As described earlier, a feature is a criteria that is considered by the neural network for which a result is assigned based upon an evaluation of the criteria. For example, suppose a criteria that needs evaluated is “whether the four-digit number [i.e. year in the date being evaluated] begins with a 19 or 20”. Further suppose that a feature ID of 309 is assigned to the true evaluation of that criteria, and a feature ID of 310 is assigned to a false evaluation of that criteria. If the date actually begins with 19, then the feature ID of 309 would evaluate to true (since the date does begin with a 19 or 20), and the feature ID of 310 would evaluate to false. Several additional examples of features that can be evaluated are described in further detail in FIGS. 7a-7b.

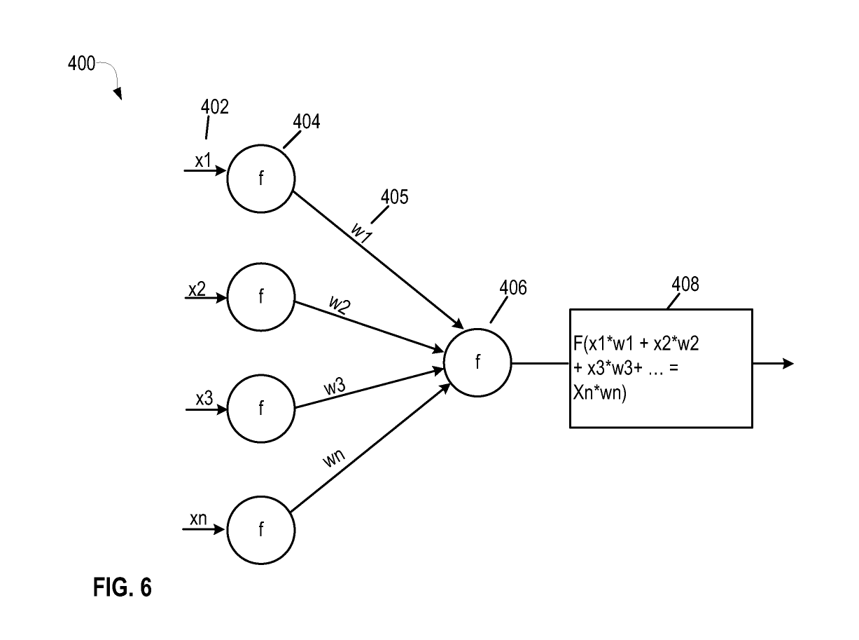

Weights are then given to the features (stage 306) so that some features are given a higher priority than others. An overall probability score is then calculated for the date (stage 308), as is described in further detail in FIG. 6. If the probability score for the date is not above a predetermined threshold (decision point 310), then the date is ignored (stage 314). If the probability score is above a predetermined threshold (decision point 310), then the date is added to a list of possible authorship dates (stage 312). If there are more dates to consider from the document (decision point 316), then the process repeats with retrieving the next date (stage 302). Once there are no more dates to consider from the document (decision point 316), then a new authorship date is chosen from the list of possible authorship dates that were identified during this process (stage 318). The date that has the highest likelihood of being the date of the document based upon the various features (criteria) considered is then selected from the list of possible dates as the authorship date for the document. In one implementation, the possible authorship date that has the highest probability score is chosen as the authorship date of the document. If none of the possible authorship dates meet the threshold, then the original date metadata for the document is used (and thus a revised date is not extracted).

FIG. 6 is a diagrammatic view for one implementation illustrating a single layer neural network (e.g. a perceptron model) being used to generate the revised authorship date for a document. An analysis of all of the dates that were identified as possible authorship dates is performed using a single layer neural network. The single layer neural network is a simple connected graph 400 with several input nodes 404, one output node 406, weights of links (w1,w2,w3, . . . wn) 405 and an activation function (f) 408. Input values (x1,x2,x3 . . . xn) 402, also called input features, are given to the input nodes 402 at once, and are multiplied by the corresponding weights (w1,w2,w3, . . . wn) 405.

The sum of all the multiplied values is passed to activation function (f) 408 to produce an output. A single probability score is then produced by the activation function (f) 408, which indicates a grand total probability score for how the particular date scored in all the various features (criteria) considered (i.e. how likely that date is the “authorship date” of the document). Numerous examples of criteria that can be evaluated to determine the likelihood that a given date is the authorship date are shown in FIGS. 7a-7b, which will be discussed next.

FIGS. 7a-7b contains a diagrammatic view 450 of exemplary features of one implementation that can be used to help determine whether a date should be included as a possible authorship date of a document. An attribute ID 452 is shown, along with a feature ID 454 and a description 456. The attribute ID 452 is a unique identifier for a set of features being evaluated. Each attribute ID 452 can contain multiple feature IDs. For example, attribute ID 1001 (458) is shown with two feature IDs, 305 (460) and 306 (462). If the date being evaluated is a four-digit number, then the feature ID 305 (460) would evaluate to true, and the feature ID 306 (462) would evaluate to false. This is an example of a “true/false” feature set that can be evaluated.

Instead of or in addition to “true/false” feature sets, feature sets containing ranges or buckets of criteria that are being evaluated can also be used. Take attribute ID 2001 for example. Attribute ID 2001 has six different feature IDs assigned to it, starting with 5 (464) and ending with 10 (466). Feature ID 5 (464) may be used to hold a true evaluation for the number of characters in the previous line falling into the range of zero to ten. Feature ID 10 (466) may be used to hold a true evaluation for the number of characters in the previous line falling into the range of forty-five and higher. The features in between feature ID 5 (464) and feature ID 10 (466) may cover the ranges in between. The “true/false” feature sets and the “ranges or buckets of feature sets” are just two non-limiting examples of the types of feature sets that can be used by the single layer neural network to evaluate how likely a given date being evaluated is to be the authorship date. These are just provided for the sake of illustration, and any other type of features that could be evaluated by a single layer neural network could also be used in other implementations.

As shown in FIG. 8, an exemplary computer system to use for implementing one or more parts of the system includes a computing device, such as computing device 500. In its most basic configuration, computing device 500 typically includes at least one processing unit 502 and memory 504. Depending on the exact configuration and type of computing device, memory 504 may be volatile (such as RAM), non-volatile (such as ROM, flash memory, etc.) or some combination of the two. This most basic configuration is illustrated in FIG. 8 by dashed line 506.

Additionally, device 500 may also have additional features/functionality. For example, device 500 may also include additional storage (removable and/or non-removable) including, but not limited to, magnetic or optical disks or tape. Such additional storage is illustrated in FIG. 8 by removable storage 508 and non-removable storage 510. Computer storage media includes volatile and nonvolatile, removable and non-removable media implemented in any method or technology for storage of information such as computer readable instructions, data structures, program modules or other data. Memory 504, removable storage 508 and non-removable storage 510 are all examples of computer storage media. Computer storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can accessed by device 500. Any such computer storage media may be part of device 500.

Computing device 500 includes one or more communication connections 514 that allow computing device 500 to communicate with other computers/applications 515. Device 500 may also have input device(s) 512 such as keyboard, mouse, pen, voice input device, touch input device, etc. Output device(s) 511 such as a display, speakers, printer, etc. may also be included. These devices are well known in the art and need not be discussed at length here.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims. All equivalents, changes, and modifications that come within the spirit of the implementations as described herein and/or by the following claims are desired to be protected.

For example, a person of ordinary skill in the computer software art will recognize that the examples discussed herein could be organized differently on one or more computers to include fewer or additional options or features than as portrayed in the examples.

What is claimed is:

1. A method for calculating a revised authorship date for a document using a neural network comprising the steps of:
determining a portion of a document to select to look for possible authorship dates;
retrieving the possible authorship dates from the portion of the document; and
generating a revised authorship date of the document using a neural network.

2. The method of claim 1, further comprising the steps of:
performing date normalization to revise a format of the revised authorship date.

3. The method of claim 1, wherein the neural network is a single layer neural network.

4. The method of claim 1, wherein the generating the revised authorship date step comprises the steps of:
accessing a possible authorship date from the possible authorship dates that were retrieved;
extracting features for the possible authorship date;
giving a weight to the features;
calculating an overall probability score for the features;
when the overall probability score is above a pre-determined threshold, adding the possible authorship date to a list of possible authorship dates for the document;
repeating the accessing, extracting, giving, calculating, and adding steps for each of the possible authorship dates accessed in the portion of the document; and
choosing the revised authorship date from the list of possible authorship dates.

5. The method of claim 4, wherein the revised authorship date is chosen by selecting a date with a highest overall probability score in the list of possible authorship dates.

6. The method of claim 1, further comprising the steps of:
outputting the revised authorship date to a requesting application.

7. The method of claim 6, wherein the revised authorship date is output to a search engine.

8. The method of claim 6, wherein the revised authorship date is output to a content management application.

9. The method of claim 6, wherein the revised authorship date is output to a file copy process.

10. The method of claim 1, wherein the determining, retrieving, and generating steps are initiated upon request from a requesting application for the revised authorship date of the document.

11. The method of claim 1, wherein the portion of the document to select is a pre-defined number of characters from one or more sections of the document.

12. The method of claim 11, wherein the one or more sections of the document include a beginning section and an ending section of the document.

13. The method of claim 1, wherein the possible authorship dates are retrieved based upon rules for identifying dates in a plurality of formats.

14. A method for calculating a revised authorship date for a document comprising the steps of:
retrieving a possible authorship date from a document;
extracting features for the possible authorship date;
giving a weight to the features;
calculating an overall probability score for the features;
when the overall probability score is above a pre-determined threshold, adding the possible authorship date to a list of possible authorship dates for the document;
repeating the retrieving, extracting, giving, calculating, and adding steps for a plurality of possible authorship dates; and
choosing the revised authorship date from the list of possible authorship dates.

15. The method of claim 14, wherein the revised authorship date is chosen by selecting a date with a highest overall probability score in the list of possible authorship dates.

16. The method of claim 14, wherein the revised authorship date is chosen by using a single layer neural network.

17. A computer-readable medium having computer-executable instructions for causing a computer to perform steps comprising:
receiving a request from a requesting application for an authorship date for a document;
calculating the authorship date for the document using a neural network; and
sending the authorship date back to the requesting application.

18. The computer-readable medium of claim 17, wherein the requesting application is an application that is displaying the document.

19. The computer-readable medium of claim 17, wherein the requesting application is a search engine.

20. The computer-readable medium of claim 17, wherein the requesting application is a content management application.
